(19) United States
(12) Patent Application Publication
(10) Pub. No.: US 2015/0264432 A1
(43) Pub. Date: Sep. 17, 2015

(54) SELECTING AND PRESENTING MEDIA PROGRAMS AND USER STATES BASED ON USER STATES

(71) Applicant: Sylvia Hou-Yan Cheng, San Francisco, CA (US)

(72) Inventor: Sylvia Hou-Yan Cheng, San Francisco, CA (US)

(73) Assignee: AliphCom, San Francisco, CA (US)

(21) Appl. No.: 14/214,086

(22) Filed: Mar. 14, 2014

(51) Int. Cl. H04N 21/442; H04N 21/462; H04N 21/4402; H04N 21/422; H04N 21/431

(52) U.S. Cl. CPC H04N 21/44218; H04N 21/42201; H04N 21/42202; H04N 21/4312; H04N 21/4402; H04N 21/462

(57) ABSTRACT

Techniques for selecting and presenting media programs and user states are described. Disclosed are techniques for receiving data representing a distance between a display and a wearable device is below a threshold, receiving data representing a user state, and determining that a condition is satisfied based on the user state, the condition being associated with a type of media program. Data representing a media program may be selected based on the type of media program. Presentation of the data representing the media program and information associated with the user state at the display may be caused.

### CROSS REFERENCE TO RELATED APPLICATIONS

This application is related to co-pending U.S. patent application Ser. No. 13/954,331, filed Jul. 30, 2013; this application is also related to co-pending U.S. patent application Ser. No. 13/954,367, filed Jul. 30, 2013; all of which are incorporated by reference herein in their entirety for all purposes.

### FIELD

Various embodiments relate generally to electrical and electronic hardware, computer software, human-computing interfaces, wired and wireless network communications, telecommunications, data processing, wearable devices, and computing devices. More specifically, disclosed are techniques for presenting and recommending media content based on media content responses determined using sensor data.

### BACKGROUND

Many types of media programs exist to suit the different habits, tastes, and needs of different people. Conventionally, suggestions and recommendations on media programs are generally made to users based on the media programs that the user has watched in the past. However, the suggested media programs may not be suitable for a current situation of the user or users. For example, a user may have a history of watching a certain type of media program, such as action movies. Conventional devices may suggest that the user watch an action movie, even if it is currently close to the user's bedtime and the user has not had enough sleep. The user may follow the suggestion without considering whether the action movie would affect his sleep.

Thus, what is needed is a solution for selecting and presenting media programs without the limitations of conventional techniques.

### BRIEF DESCRIPTION OF THE DRAWINGS

Various embodiments or examples (“examples”) are disclosed in the following detailed description and the accompanying drawings:

FIG. 1 illustrates a media device with a media program manager, according to some examples;

FIG. 2 illustrates an application architecture for a media program manager, according to some examples;

FIG. 3 illustrates an application architecture for a condition matcher to be used with a media program manager, according to some examples;

FIG. 4 illustrates a display that is managed by a media program manager, according to some examples;

FIG. 5 illustrates a network of wearable devices of a plurality of users, the wearable devices to be used with one or more media program managers, according to some examples;

FIG. 6 illustrates a process for a media program manager, according to some examples;

FIG. 7 illustrates another process for a media program manager, according to some examples; and

FIG. 8 illustrates a computer system suitable for use with a media content response manager, according to some examples.

### DETAILED DESCRIPTION

Various embodiments or examples may be implemented in numerous ways, including as a system, a process, an apparatus, a user interface, or a series of program instructions on a computer readable medium such as a computer readable storage medium or a computer network where the program instructions are sent over optical, electronic, or wireless communication links. In general, operations of disclosed processes may be performed in an arbitrary order, unless otherwise provided in the claims.

A detailed description of one or more examples is provided below along with accompanying figures. The detailed description is provided in connection with such examples, but is not limited to any particular example. The scope is limited only by the claims and numerous alternatives, modifications, and equivalents are encompassed. Numerous specific details are set forth in the following description in order to provide a thorough understanding. These details are provided for the purpose of example and the described techniques may be practiced according to the claims without some or all of these specific details. For clarity, technical material that is known in the technical fields related to the examples has not been described in detail to avoid unnecessarily obscuring the description.

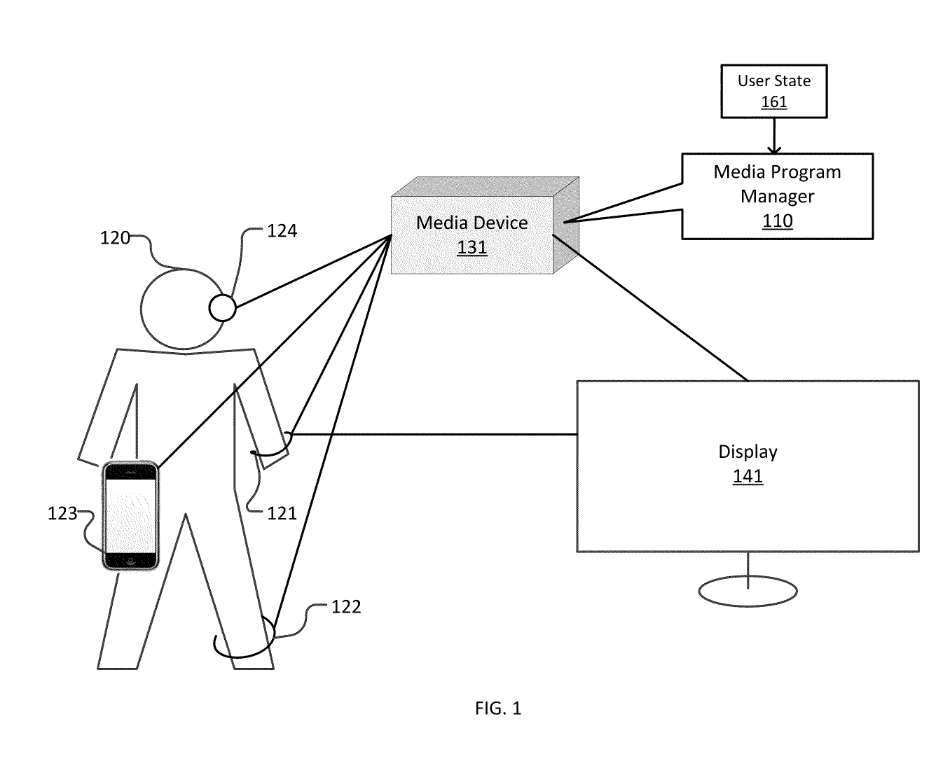

FIG. 1 illustrates a media device with a media program manager, according to some examples. As shown, FIG. 1 includes a user 120, wearable devices 121-124, a media device 131, a display 141, and a media program manager 110. Media program manager 110 may be configured to select a media program based on a user state 161, such as a user's current, past, or future activity, mood or emotions, sleep quality or quantity, schedule, and the like, and to cause presentation of the media program and information associated with the user state at display 141. A media program may be any audio and/or visual data that may be presented at a display or other user interface, such as a television program (e.g., broadcast, cable, etc.), a movie, motion picture, or video clip (e.g., via DVD, video tape, electronic media, streaming (e.g., Netflix, Hulu, YouTube, etc.), etc.), a song or other audio content, an advertisement or commercial, and the like. A media program may include a series of graphics or images, which may be presented as moving images at a display. Media program manager 110 may receive data representing a distance between display 141 and one or more wearable devices 121-124 is below a threshold. This may indicate that display 141 is within a viewable distance of user 120. The distance being below a threshold may trigger media program 110 to turn on display 141, or to begin the process of selecting a media program for user 120. Media program manager 110 may receive data representing user state 161, which may be determined based on sensor data captured from one or more sensors coupled to wearable devices 121-124. Media program manager 110 may select and present a media program based on user state 161. Media program manager 110 may also select and present a media program based on other information, such as the time of day, an environmental state, states of other users, and the like.

Media program manager 110 may determine that a condition or criteria is satisfied based on user state 161, the condition being associated with a type of media program. The condition may relate to a variety of parameters associated with user state 161. The condition may relate to a user's current, past, and/or future activity, mood or emotions, sleep quality or quantity, schedule, and the like. The condition may indicate a genre or type of media program that is suitable or appropriate for the condition. The media program type may serve as a reward (or punishment) for having satisfied the condition. A media program type may be a comedy, action, drama, tragedy, news, educational, health, cooking, work-out or exercise, food and dining, music (e.g., MTV, song, etc.), a video or computer game, and the like. Once the condition is satisfied or met, a type of media program may be identified. In some examples, a condition may indicate a plurality of media program types that may be suitable. One of the plurality of media program types may be selected. The condition may include a range or tolerance within which it is considered to be satisfied. The condition may be, for example, a number of steps taken by a user, a number of hours of sleep, a period of time since an activity was last performed, a mood or emotion of a user, a health or physical condition of a user, and the like. Media program manager 110 may select data representing a media program based on a media program type indicated by the condition. A media program may be a television program, movie, film, video clip, audio content, soundtrack, commercial, and the like. For example, the media program type may be a cooking show, and the media program may be a specific cooking show. Media program types and media programs may be customized or modified by a user. For example, a user may specify her favorite media program types or media programs.

Media program manager 110 may cause presentation of the media program and information associated with user state 161 at display 141. The information associated with user state 161 may be related to a variety of parameters associated with user state 161. The information associated with user state 161 may be qualitative or quantitative, may be in relation to or a comparison with another user state, a goal, or historic performance, may be in textual or graphic form, and the like. The information associated with user state 161 may include reasoning for why a certain media program is being selected and presented. For example, the information may state, “You have reached your goal for walking 10,000 steps today! You should now reward yourself with your favorite sit-com!” The information associated with user state 161 may be presented as an overlay on the media program. The information associated with user state 161 may be presented in the foreground, while the media program continues to be presented in the background. The information associated with user state 161 may be presented with a level of transparency, to allow a limited view of the media program. The presentation of media program may also be adjusted such that it is adjacent to the information associated with user state 161. For example, a resolution or dimension of the media program may be modified, for example, it becomes narrower, and the information associated with user state 161 may be presented as a sidebar. As another example, a resolution of the media program may become shorter, so that the information associated with user state 161 may be presented as a bar near the bottom of display 141.

Display 141 may be a device configured to present information in a visual or tactile form. Examples include cathode ray tube displays (CRT), liquid crystal displays (LCD), light-emitting diodes (LED), interferometric modulator display (IMOD), electrophoretic ink (E Ink), organic light-emitting diode (OLED), tactile electronic displays, and the like.

In some examples, display 141 may receive input signals from media device 131. Media device 131 may generate output based on input data signals, such as over-the-air or broadcast signals, satellite signals (e.g., satellite television), streaming signals (e.g., streaming over the Internet or a network), from a disc (e.g., DVD, VCD, gaming module, etc.), and the like. In other examples, display 141 may receive input signals from a cable television set-top box (not shown), which may generate output based on cable television input data signals. Either media device 131 or a set-top box may be implemented as a separate device from display 141, or may be integrated with, fabricated with, or located on display 141.

Wearable devices 121-124 may be may be worn on or around an arm, leg, ear, or other bodily appendage or feature, or may be portable in a user's hand, pocket, bag or other carrying case. As an example, a wearable device may be a data-capable band 121-122, a smartphone or mobile device 123, and a headset 124. Other wearable devices such as a watch, data-capable eyewear, cell phone, tablet, laptop or other computing device may be used.

Wearable devices 121-124 may be configured to capture or detect data using one or more sensors. A sensor may be internal to a wearable device (e.g., a sensor may be integrated with, manufactured with, physically coupled to the wearable device, or the like) or external to a wearable device (e.g., a sensor physically coupled to wearable device 121 may be external to wearable device 122, or the like). A sensor external to a wearable device may be in data communication with the wearable device, directly or indirectly, through wired or wireless connection. Various sensors may be used to capture various sensor data. Sensor data may include physiological data, activity data, environmental data, and the like. For example, a galvanic skin response (GSR) sensor may be used to capture or detect a galvanic skin response (GSR) of user 120. A heart rate monitor may be used to capture a heart rate. A thermometer may be used to capture a temperature. An accelerometer may be used to detect acceleration or other motion data. A Global Positioning System (GPS) receiver may be used to capture a location of user 120.

Elements 121-124, 131, and 141 may be in data communication with each other, directly or indirectly, using wired or wireless communications. In some examples, media program manager 110 may be implemented on media device 131. Wearable devices 121-124 may communicate with media device 131, including transmitting sensor data to media content response manager 110 for analysis. Display 141 may also communicate with media device 131, and data signals associated with media content or other information presented at display 141 may be communicated. In other examples, media program manager 110 may be implemented on wearable devices 121-124, a server (not shown), or another device. Media device 131, which may be integrated with or separate from display 141, may be in data communication with wearable devices 121-124, a server, or another device. Still, other implementations may be possible.

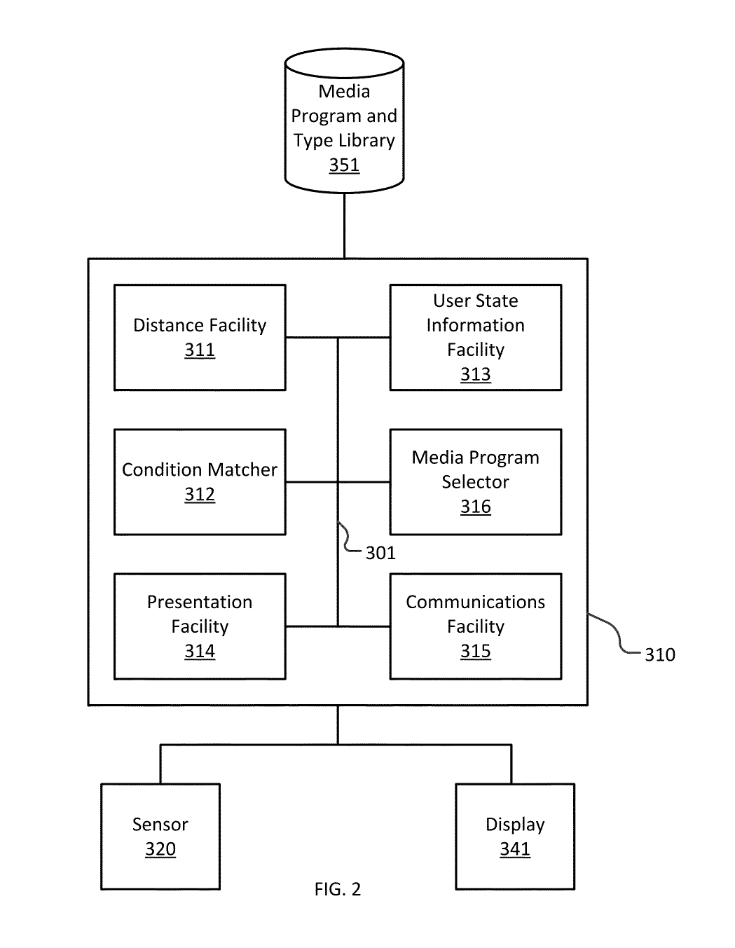

FIG. 2 illustrates an application architecture for a media program manager, according to some examples. As shown, a media program manager 310 includes bus 301, distance facility 311, user state facility 313, condition matcher facility 312, media program selector facility 316, presentation facility 314, and communications facility 315. Media program manager 310 is coupled to media program and type library 351, sensor 320, and display 341. Communications facility 315 may include a wireless radio, control circuit or logic, antenna, transceiver, receiver, transmitter, resistors, diodes, transistors, or other elements that are used to transmit and receive data, including broadcast data packets, from other devices. In some examples, communications facility 315 may be implemented to provide a “wired” data communication capability such as an analog or digital attachment, plug, jack, or the like to allow for data to be transferred. In other examples, communications facility 315 may be implemented to provide a wireless data communication capability to transmit digitally encoded data across one or more frequencies using various types of data communication protocols, such as Bluetooth, Wi-Fi, 3G, 4G, without limitation. As used herein, “facility” refers to any, some, or all of the features and structures that are used to implement a given set of functions, according to some embodiments. Media program manager 310 may be implemented at a media device, or it may be implemented at display 341, a server, or another device.

Distance facility 311 may be configured to determine whether a distance between a wearable device and display 341 and to determine whether the distance is below a threshold. Distance may be determined using various types of sensor data, which may be received from sensor 320 or communications facility 315. For example, a sensor located at display 341 (or a media device or another device near display 341) may detect the strength, amplitude, or intensity of a wireless signal (e.g., Wi-Fi, Bluetooth, etc.) being transmitted from a device, such as a wearable device, which may be used to determine distance. For example, the higher the intensity of the signal received, the closer the wearable device is to display 341. As another example, an ultrasonic sensor may be used to detect the distance between devices, users and/or objects. An ultrasonic sensor may generate high frequency sound waves and evaluate the echo which is received back at the sensor. Other waves, such as radar, sonar, and the like, may also be used. Examples of implementations may be found in co-pending U.S. patent application Ser. No. 13/954,331, filed Jul. 30, 2013, and co-pending U.S. patent application Ser. No. 13/954,367, filed Jul. 30, 2013, all of which are incorporated by reference herein in their entirety for all purposes. Distance facility 311 may determine whether the distance is below a threshold. The threshold may indicate a distance within which display 341 is viewable by a user of the wearable device. The threshold may indicate a distance within which display 341 may present media or information to a user. The threshold may indicate that user is in front of display 341. In some examples, distance facility 311 may be integrated with or implemented at media program manager 310 (as shown). In other examples, distance facility 311 may be separate from media program manager 310 and may communicate with media program manager 310 using communications facility 315. Distance facility 311 may generate data representing whether the distance is below a threshold and may communicate the data with media program manager 310 using bus 301 and/or communications facility 315. Data representing whether the distance is below a threshold may be received by media program manager 310. In some examples, distance facility may be used to determine that more than one wearable device or user is within the threshold distance. Media program manager 310 may select and present a media program based on the user states of all or a subset of nearby users. Media program manager 310 may present information associated with one or more user states.

User state facility 313 may be configured to determine a user state based on sensor data. Sensor data may be received from one or more local sensors coupled to media program manager 310 and/or one or more remote sensors using communications facility 315. User state facility 313 may compare sensor data to one or more templates or conditions to determine a user state, including a duration, intensity, and other information associated with the user state. User state facility 313 may compare sensor data to one or more templates to determine a match. A template may include conditions associated with a variety of sensor data. For example, one template may include a set of sensor data indicating that a user is sleeping. This may include conditions such as a low level of motion, a low level of sound, a low level of lighting, a time of day, and the like. Another template may be a set of sensor data indicating that a user is exercising. This may include a high level of motion, a high heart rate, and the like. User state facility 313 may be used to determine a mood of a user, an activity of a user, a health condition of a user, a sleep state of a user, and other states or conditions associated with a user, as well as related information, such as a duration of a mood of a user, a time since an activity of a user, a difference between a current physiological state (e.g., heart rate) and an average of past physiological states, and the like. A sleep state may include being awake, being asleep, being in deep sleep, being in light sleep, and the like. For example, a low level of motion and a low GSR may indicate deep sleep. In some examples, user state facility 311 may be integrated with or implemented at media program manager 310 (as shown). In other examples, user state facility 313 may be separate from media program manager 310 and may communicate with media program manager 310 using communications facility 315. User state facility 313 may generate data representing a user state and may communicate the data with media program manager 310 using bus 301 and/or communications facility 315. Data representing a user state may be received by media program manager 310. In some examples, a plurality of data representing a plurality of user states may be received by media program manager 310. The plurality of user states may be associated with a plurality of users who are within a threshold distance of display 341. An environmental state facility (not shown) may be used to determine an environmental state based on sensor data. Environmental states may include information related to temperature, altitude, location, humidity, ambient light, ambient sound, and the like. Data representing an environmental state may also be received by media program manager 310. Data representing a user's schedule may also be received by media program manager 310. A user may manually input his schedule using a user interface coupled to media program manager 310. Data representing a user's schedule may also be received using communications facility 315 from a server or database. Still, other data may be received by media program manager 310.

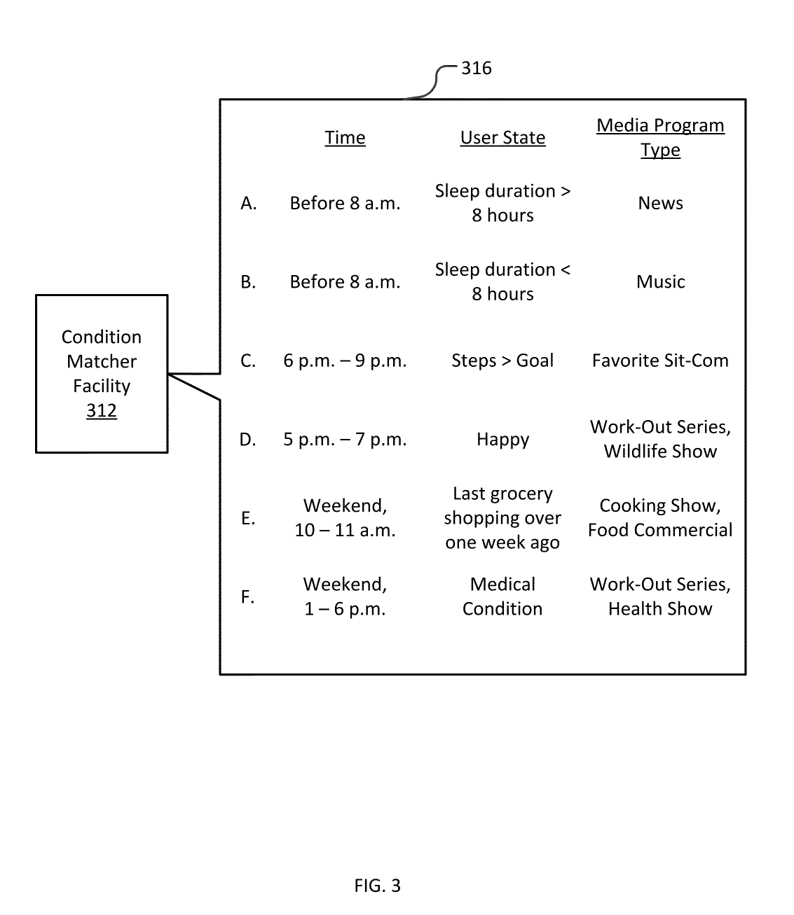

Condition matcher 312 may be configured to determine that a condition is satisfied based on the user state, the condition being associated with a type of media program. Condition matcher 312 may compare the user state to one or more conditions to determine a match. A match may be found if there is substantial similarity or similarity within a tolerance. For example, a condition may include a range of a number of steps taken by a user on a given day, such as 8,000-10,000 steps. In some examples, a match may be found if the user state indicates that 8,000-10,000 steps were taken. In some examples, a match may be found if the number of steps taken by the user is within a tolerance. The tolerance may be a percentage or number, such as 5% of the number required by the condition. For example, a match may be found if a user state indicates 7,850 steps were taken, which may be within a tolerance of the condition. A condition may indicate a media program type that may be used to determine a media program to be presented at display 341. In some examples, one condition may indicate more than one media program type. In some examples, a media program belonging to one of the plurality of media program types indicated by a condition may be presented. In some examples, one of the plurality of media program types may be selected based on other conditions or criteria. In some examples, a plurality of conditions may be satisfied based on the user state, wherein each condition may indicate more than one media program type. A media program type that is common to all or a majority of the conditions that are satisfied may be selected. For example, a first condition, such as having walked over 8,000 steps, may be associated with the media program types, such as comedy and cooking. A second condition, such as having slept over 7 hours, may be associated with the media program types, such as health and cooking Both the first and second conditions may be satisfied based on a user state (e.g., the user both walked over 8,000 steps and slept over 7 hours). A common media program type of the conditions that were satisfied may be selected (e.g., cooking). In some examples, more than one user state may be used by condition matcher 312. For example, two wearable devices of two users may be determined to be within a threshold distance, and two user states are received by media program manager 310. A common media program type associated with a condition that is satisfied by at least one of the user states may be selected. For example, the first user state may satisfy a first condition, and the second user state may satisfy a second condition. A media program type that is associated with the first condition and the second condition may be selected. In some cases, a common media program type may not be found, and one media program type may be selected, either randomly or based on other condition or criteria. Other functionalities and uses may be performed by condition matcher 312 (e.g., see FIG. 3).

Media program selector 316 may be configured to select a media program based on the media program type determined by condition matcher 312. Media program selector 316 may be configured to select a media program from a plurality of media programs stored at media program and type library 351. Media program and type library 351 may store data representing a media program, such as a news show, a movie, a video clip, and the like, as well as its associated type or types. The type or types may be stored as a tag to the data representing the media program. For example, a movie may be tagged with both the types comedy and health. A type of a media program may be entered or modified by a user, or may be preset by a content provider or other source. A type of media program may be determined based on an aggregation of input from a plurality of users. For example, a vote or poll may determine a type of a media program. Media program and type library 351 may store data representing a media program with a time associated with a presentation of the media program. For example, a media program may be a television program, which may be broadcast or shown according to a programming schedule provided by a content provider. The media programs available for presentation may change as a function of time. Media program selector 316 may receive data representing a media program type from condition matcher 312. Media program selector 316 may search or scan through media program and type library 351 to select a media program having the media program type.

Media program and type library 351 may be implemented using various types of data storage technologies and standards, including, without limitation, read-only memory (“ROM”), random access memory (“RAM”), dynamic random access memory (“DRAM”), static random access memory (“SRAM”), static/dynamic random access memory (“SDRAM”), magnetic random access memory (“MRAM”), solid state, two and three-dimensional memories, Flash®, and others. Media program and type library 351 may also be implemented on a memory having one or more partitions that are configured for multiple types of data storage technologies to allow for non-modifiable (i.e., by a user) software to be installed (e.g., firmware installed on ROM) while also providing for storage of captured data and applications using, for example, RAM. Media program and type library 351 may be implemented on a memory such as a server that may be accessible to a plurality of users, such that one or more users may share, access, create, modify, or use media programs and types stored therein.

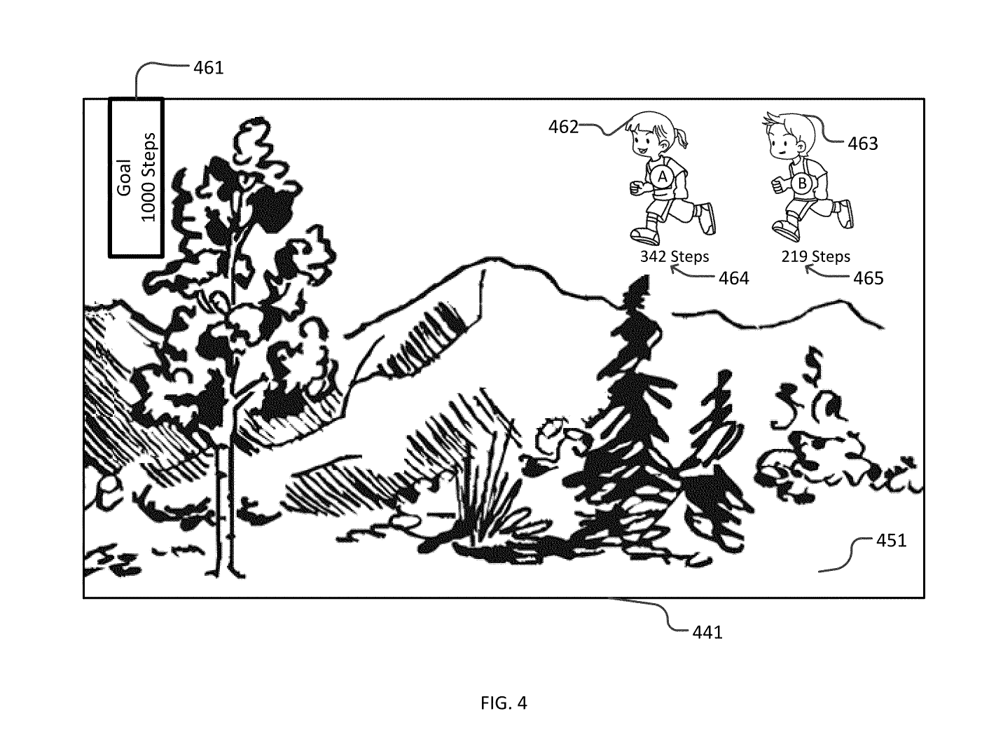

Presentation facility 314 may be configured to cause presentation of the media program and information associated with the user state at display 341. In some examples, the information associated with the user state may be displayed as an overlay on the media content. Media content may be presented in a background, while information associated with a user state may be presented in a foreground. The foreground may have a degree of transparency, so that the media content may continue to be viewable. The foreground may occupy a small portion of display 341, or it may occupy the entire surface of display 341. The information associated with the user state may be presented in a color that contrasts with the media program in the background. The information associated with the user state may be presented on a banner that is overlaid on the media program. In some examples, the information associated with the user state may be displayed adjacent to the media program. A resolution, size, or dimension of the media program may be adjusted or modified to accommodate the information associated with the user state. For example, the presentation of the media program may become narrower to accommodate a sidebar displaying information associated with a user state. In some examples, presentation facility 341 may determine how to present a media program based on a user state. Presentation facility 341 may determine whether to use an overlay based on a user state. For example, if a user state indicates a user is tired, presentation facility 341 may present information associated with the user state as an overlay. If a user state indicates a user is happy, the information associated with the user state may be presented adjacent to the media program. In some examples, information associated with more than one user state may be displayed. In some examples, information associated with one or more user states may be presented in textual and/or graphical format. Graphical formats may include graphics that indicate the progress of a user, an avatar representing the user, a bar graph, line graph, or other chart presenting information associated with the user state, and the like. Information associated with the user state may include a reason for selecting the media program being presented. For example, a media program may be presented as a reward for a user having achieved a certain goal. As another example, a media program may be presented to motivate a user to do an activity or otherwise change his user state. In some examples, presentation facility 341 may determine or modify a contrast, brightness, and/or sharpness associated with presentation of the media program based on the user state. For example, the user state may indicate that a user is tired, and presentation facility 341 may lower the brightness of the presentation of the media program at display 341. Display 341 may be integrated with media content response manager 310, or may be separate from media content manager 310. Display 341 may be in wired or wireless communication with media content response manager 310. Still, other functionalities and uses may be performed by presentation facility 314 (e.g., see FIG. 4).

Media program manager 310 may receive sensor data from sensor 320. Sensor 320 may be various types of sensors and may be one or more sensors. Sensor 320 may be local or external to a wearable device, and may or may not be in data communication with a wearable device. Sensor 320 may be configured to detect or capture an input to be used by media program manager 310. For example, sensor 320 may detect an acceleration (and/or direction, velocity, etc.) of a motion over a period of time. For example, sensor 320 may include an accelerometer. An accelerometer may be used to capture data associated with motion detection along 1, 2, or 3-axes of measurement, without limitation to any specific type of specification of sensor. An accelerometer may also be implemented to measure various types of user motion and may be configured based on the type of sensor, firmware, software, hardware, or circuitry used. For example, sensor 320 may include a gyroscope, an inertial sensor, or other motion sensors. As another example, sensor 320 may include a galvanic skin response (GSR) sensor, a bioimpedance sensor, an altimeter/barometer, light/infrared (“IR”) sensor, pulse/heart rate (“HR”) monitor, audio sensor (e.g., microphone, transducer, or others), pedometer, velocimeter, GPS receiver or other location sensor, thermometer, environmental sensor, or others. A GSR sensor may be used to detect a galvanic skin response, an electrodermal response, a skin conductance response, and the like. A bioimpedance sensor may be used to detect a bioimpedance, or an opposition or resistance to the flow of electric current through the tissue of a living organism. GSR and/or bioimpedance may be used to determine an emotional or physiological state of an organism. For example, the higher the level of arousal (e.g., physiological, psychological, emotional, etc.), the higher the skin conductance, or GSR. An altimeter/barometer may be used to measure environmental pressure, atmospheric or otherwise, and is not limited to any specification or type of pressure-reading device. An IR sensor may be used to measure light or photonic conditions. A heart rate monitor may be used to measure or detect a heart rate. An audio sensor may be used to record or capture sound. A pedometer may be used to measure various types of data associated with pedestrian-oriented activities such as running or walking. A velocimeter may be used to measure velocity (e.g., speed and directional vectors) without limitation to any particular activity. A GPS receiver may be used to obtain coordinates of a geographic location using, for example, various types of signals transmitted by civilian and/or military satellite constellations in low, medium, or high earth orbit (e.g., “LEO,” “MEO,” or “GEO”). In some examples, differential GPS algorithms may also be implemented with a GPS receiver, which may be used to generate more precise or accurate coordinates. In other examples, a location sensor may be used to determine a location within a cellular or micro-cellular network, which may or may not use GPS or other satellite constellations. A thermometer may be used to measure user or ambient temperature. An environmental sensor may be used to measure environmental conditions, including ambient light, sound, temperature, etc. Still, other types and combinations of sensors may be used. Sensor data captured by sensor 320 may be used to determine a distance between objects, a user state, an environmental state, and the like, as described herein. Still, other implementations of media program manager 310 may be used.

FIG. 3 illustrates an application architecture for a condition matcher to be used with a media program manager, according to some examples. As shown, FIG. 3 includes a condition matcher 312 and a set of conditions 316. A condition may be based on a user state. As shown, examples of conditions of user states may include a sleep duration being over a threshold (e.g., 8 hours), a sleep duration being under a threshold (e.g., 8 hours), a number of steps being above a goal, a mood or emotional state being happy or content, a time past since an activity was performed (e.g., grocery shopping), and a medical or health condition, without limitation. Each condition may be associated with one or more types of media program. As shown examples, include news, music, situation comedy (“sit-com”), work-out series (e.g., yoga, aerobics, etc.), wildlife show (e.g., documentary or other media program on animals and wildlife), cooking show, food commercial, and health show, without limitation. Additional conditions may be considered. As shown, for example, time may be considered, such as the time of day, the day of the week, and the like. Other examples include environmental conditions, states of other users, and the like. The conditions may be manually entered or modified by a user using a user interface, may be automatically determined based on a historic data of the user or others, or may be preinstalled by a manufacturer or producer, or the like. Conditions may be automatically generated based on historic user states. For example, a user state facility may determine that a user generally sleeps 8 hours per night, and a user state facility may determine that the user generally feels refreshed and happy after 8 hours of sleep. A condition may be generated providing that if 8 hours of sleep are attained, then select news as the media program type. News may be appropriate as the user is refreshed and ready to become aware of the latest news. As another example, data from a plurality of users may indicate that a majority of people with a certain medical condition watch health shows or work-our series during weekend afternoons. This data may be stored in a server that is accessible to a plurality of users, and determined using sensor data associated with the plurality of users. A condition may be generated providing that if the medical condition exists, and the current time is a weekend afternoon, select work-out series or health show as the media program type. A user may further customize or personalize the media program type. For example, a user may specify that a media program type is not sit-coms in general, but specifically her favorite sit-com series.

In some examples, a user state may satisfy two conditions. For example, the time is currently Saturday 5 p.m., and the user state indicates the user is happy and has a medical condition. Conditions D. and F. may both be satisfied. A common media program type to the two conditions may be selected, for example, work-out series. As another example, the time is currently 6 p.m., and the user is happy and achieved the targeted number of steps in her goal. Conditions C. and D. may be satisfied, however, no common media program type may exist. One media program type may be selected randomly, or based on other criteria, such as the types of media program she has watched recently, the media programs that are currently available, and the like. In some examples, two user states are received, each satisfying a condition. For example, a first user state may indicate that a first user slept for over 8 hours last night, while a second user state may indicate that a second user slept for less than 8 hours last night. If a common media program type exists, the common media program type may be selected. If not, one of the media program types may be selected.

In some examples, a condition may also be associated with a contrast, brightness, and/or sharpness of a presentation of a media program. A condition may indicate or suggest a contrast, brightness, and/or sharpness that is suitable or appropriate for or based on the user state. For example, a condition may inquire whether a user is tired. If it is satisfied (e.g., the user state indicates the user is tired), then a lower brightness and a lower contrast may be used for presenting the media program. As another example, a condition that a user state indicate that a user is alert and that a current time is between 7 and 9 p.m. may be associated with increasing contrast, brightness, and sharpness, which may give the user a more dynamic or vivid presentation of the media program. In some examples, a condition may also be associated with how to present the media program and the information associated with the user state. A condition may indicate or suggest whether to present an overlay based on a user state.

A condition may also be associated with other types of data, such as an environmental state, a user's schedule, and the like. An environmental state may be associated with ambient light, sound, temperature, humidity, altitude, location, and the like. For example, a condition may inquire whether the brightness of an ambient light is below a threshold. The condition may be associated with a media program type, such as a romance. A user's schedule may include information about a user's meetings, appointments, and the like. This information may be directly input to a media program manager, or may be stored in a remote server and communicated to a media program manager. For example, a condition may inquire whether there is a meeting before 10 a.m. the next day. The condition may be associated with a media program type, such as music. If the condition is satisfied, a music type of media program may be selected and presented at a display. Still, other methods for determining whether a condition is satisfied and/or selecting a media program type may be used.

FIG. 4 illustrates a display that is managed by a media program manager, according to some examples. As shown, FIG. 4 includes display 441, media program 451, and information associated with one or more user states, including avatars 462-463, steps taken 464-465, and goal 461. Display 441 may present media program 451 and information associated with one or more user states. In some examples, as shown, information associated with a user state may be presented as an overlay to the media program. The information associated with a user state may overlap with the media program. The information associated with a user state and/or the media program may be presented with a level of transparency. In other examples, information associated with a user state may be presented adjacent to the media program. Information associated with a user state may be presented as a separate window from the media program.

As shown, for example, information associated with one or more user states may include avatars 462-463, steps taken 464-465, and goal 461. For example, two user states associated with two users may be received. One or both of the two users may be within a close proximity of display 441. The proximity may be detected based on a distance between wearable devices of the two users and display 441. The proximity may also be detected based on ultrasonic sensors, voice recognition, and the like. The two users may be together, for example, both close to display 441, or physically apart. Data associated with a remote user may be received using a communications facility and/or using a server. The two users may be in a competition, for example, to determine which user would reach 1,000 steps first. Each user may send a signal to a server or other memory to initiate the competition. Sensors coupled to wearable devices of the two users may capture sensor data, which may be used to determine user states. Information associated with the user states may be presented as textual information, such as the number of steps taken 464-465. Information associated with the user states may be presented as a graphical image or chart. For example, goal 461 may be presented, and a bar, line, or other image located away from goal 461 may be used to represent a difference from goal 461. An animation may be used to show that the difference from goal 461 is becoming smaller. Information associated with the user states may be presented as avatars 462-463, which may be animated. An animation may include continuous motion of an image, such as a cartoon or computer graphics design.

Avatars 462-463 may be generated or formed based on the user states. An avatar may be a graphical or animated representation of a user. For example, a user state may indicate that a user is engaged in the activity of walking. The avatar may be animated to walk. As another example, a user state may indicate that a user is sad, and the avatar may be shown with a sad face. Avatars 462-463 may be customized or modified by a user or based on a user's biological or other information. For example, information may include sex (e.g., female), age (e.g., 18 years old), and others, which may be manually input by a user. A set of features of avatars may be stored in a memory, each feature being associated with a characteristic or information associated with a user. For example, a female avatar may be used for a female user. Still, other methods may be used for presenting a media program and information associated with a user state at display 441.

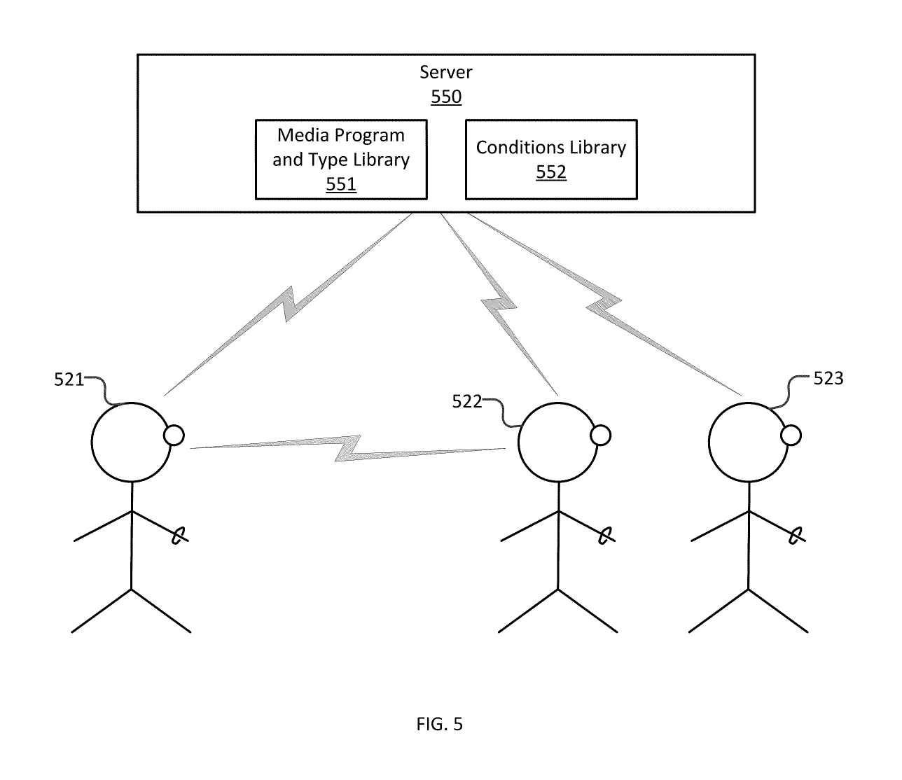

FIG. 5 illustrates a network of wearable devices of a plurality of users, the wearable devices to be used with one or more media program managers, according to some examples. As shown, FIG. 5 includes server 550, media program and type library 551, conditions library 552, and users 521-523. Each user 521-523 may have one or more wearable devices, which may interact with one or more media program managers. The wearable devices of users 921-923 may communicate with each other over a network, and may be in direct data communication with each other, or be in data communication with server 550.

Server 550 may include media program and type library 551 and conditions library 552. Media program and type library 551 may include data representing a media program and its associated type or genre. The type may be stored as a tag to the data representing the media program. The type may also be stored as a table having the types and corresponding media programs. A type associated with a media program may be predetermined, such as by a content provider, or may be entered or modified by a user. For example, a type of a media program may be predetermined (e.g., a comedy), and a user may add another type (e.g., animal show), may delete the existing type (e.g., delete comedy), and the like. A user's input may modify the type of the media program. A user may also add personalized types, such as classifying a media program with the type “favorite,” “favorite sit-com,” or the like. A portion of media program and type library 551 storing information on media programs and their associated types may be generally accessible to the public. Another portion of media program and type library 551 storing information on media programs and their associated types that may have been entered or modified by a user may be accessible to the user only. Such information may be stored as part of a profile of the user. For example, it may include tagging or classifying a media program with the type “favorite,” or another personal type. The user may select to share such information and/or his profile with a friend, granting access to the friend. The user may choose to share such information on a social network service (e.g., Facebook, Twitter, etc.). The user may choose to make such information generally accessible and available to the public. A user's input on the type associated with a media program may be sent or shared with a third party, such as a content provider, which may be used by the third party to evaluate the media program. Media program and type library 551 may include data representing a media program and a time at which the media program is available for presentation. The media programs available for presentation may be based on a programming schedule. For example, a limited number of media programs may be available on a channel (e.g., cable television channel, broadcast television channel, etc.) at a certain time. Some media programs may be available for presentation at any time or upon a user's request (e.g., via streaming, DVD, computing device, media device, and the like).

Conditions library 552 may include data representing one or more conditions and their associated media program type. For example, conditions and associated types may be stored as a table, tags, or another format (e.g., see FIG. 3). Conditions and associated types may be predetermined, or entered or modified by a user. For example, a user may modify a condition from inquiring whether the sleep duration was above 8 hours to inquiring whether the sleep duration was above 7 hours. As another example, a user may modify the media program type that a condition is associated with. A portion of conditions library 552 may store conditions and associated types that are generally accessible by the public. These conditions may be accessed, downloaded, or used by a plurality of users. A portion of conditions library 552 may store conditions and associated types that are private to a user. These may be conditions and associated types that are entered or modified by a user. These conditions and associated types may be shared by the user with other selected users, such as the user's friends, such that the conditions and associated types may also be used by them. Conditions and associated types may also be shared using a social network service. Conditions and associated may also be shared generally with the public.

Media programs and their associated types, as well as conditions and their associated types may be shared among users over a network, or may be downloaded, purchased, or retrieved from a marketplace. A marketplace may be a portal, website, or centralized service from which a plurality of users may retrieve or download resources, such as media programs and associated types as well as conditions and associated types. A marketplace may be accessible over a network, such as using server 550, or over the Internet, or other networks. Still, other implementations and configurations may be possible.

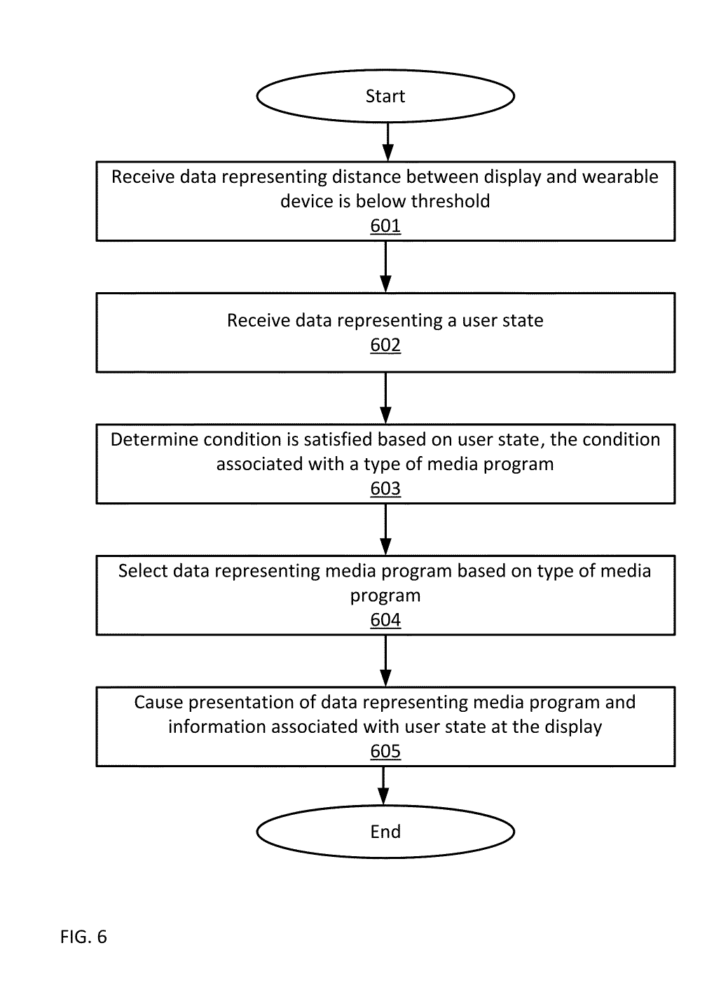

FIG. 6 illustrates a process for a media program manager, according to some examples. At 601, data representing a distance between a display and a wearable device is below a threshold may be received. Data representing a distance between a display and a wearable device is below a threshold may be received from a distance facility local to the media program manager, or from a remote device using a communications facility. Whether a distance between a display and a wearable device is below a threshold may be determined using sensor data received one or more sensors. The one or more sensors may be coupled to the display and/or the wearable device. The one or more sensors may detect or capture sensor data associated with wireless signals, such as Wi-Fi, Bluetooth, ultrasonic, radar, sonar, and the like. For example, the wearable device may transmit a wireless signal (e.g., Wi-Fi, Bluetooth, and the like), and a sensor located at the display may detect the amplitude, intensity, or strength of the wireless signal as it is being received by the sensor. The greater the amplitude, the closer the wearable device may be to the display. At 602, data representing a user state may be received. A user state may be determined using sensor data received from one or more sensors. The one or more sensors may be coupled to or in data communication with a wearable device, and may be local or remote from the wearable device. The sensor data may be compared to one or more templates or conditions to determine a user state. The user state may be associated with a user's physiological, health, emotions, activities, and the like. The user state may describe one or more current, past, and/or future conditions or situations. Data representing an environmental state, or other data, may also be received. At 603, a determination that a condition or criteria is satisfied based on the user state may be made. The condition may be associated with a type of media program. A condition may be based on a variety of parameters associated with a user state. A condition may indicate or suggest a media program type that is suitable to be presented to the user based on the user state. A condition may also be based on an environmental state or other types of data. A condition may be stored in a conditions library. At 604, data representing a media program may be selected based on the media program type. The media program may be a television program, a movie, a video clip, a webpage, and the like. The data representing a media program may be selected from a media program and type library, which may store media programs and their associated types. At 605, presentation of data representing the media program and information associated with the user state at the display may be caused. The presentation may include an overlay and/or a side-by-side view of the media program and the information associated with the user state. The information associated with the user state may be presented in textual and/or graphical form, and may include using animations and avatars. An avatar may be customized based on a user's biological information or other data. Still, other implementations may be possible.

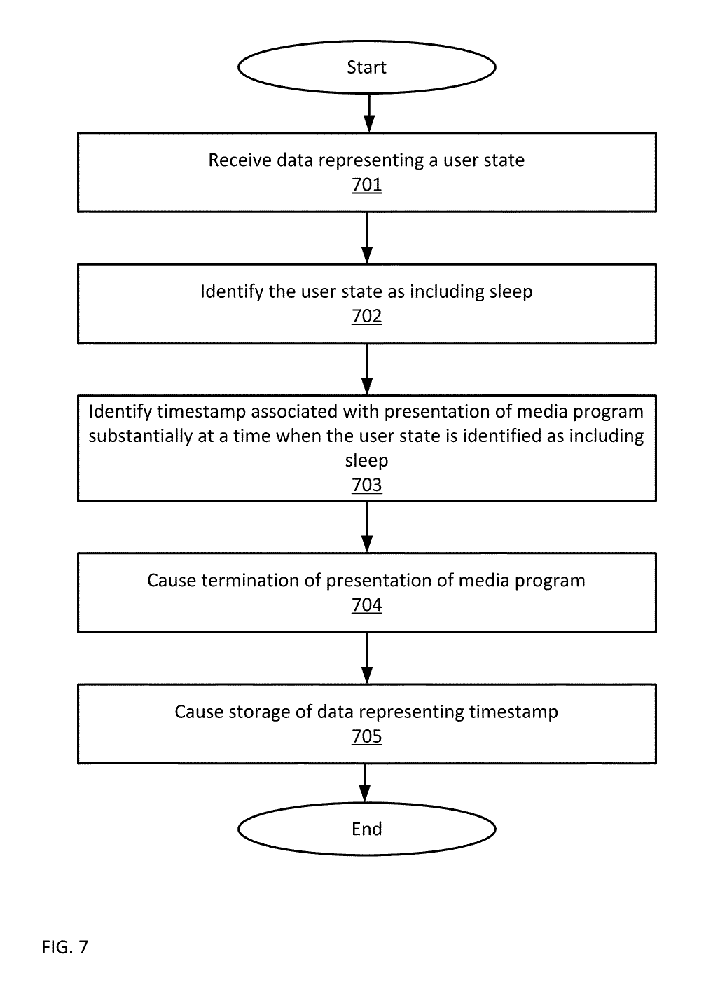

FIG. 7 illustrates another process for a media program manager, according to some examples. At 701, data representing a user state may be received. The data representing a user state may be received while a media program is being presented at a display. The user state may be determined and updated based on sensor data as the sensor data is being received. At 702, an identification that the user state includes sleep may be made. The user state may include a variety of information associated with the user, including physiological, physical, emotional, and other information. The user state may indicate that a user is asleep. At 703, a timestamp associated with the presentation of the media program may be identified substantially at a time when the user state is identified as including sleep. A timestamp of the media program at the time the user is detected as being asleep may be identified. A timestamp may indicate the time that has elapsed since the beginning of a presentation of a media program. A timestamp may use the format hh:mm, wherein hh indicates the number of hours since the beginning of the media program, and mm indicates the number of minutes since the beginning of the media program. A timestamp may also use other formats. At 704, termination of the presentation of the media program is caused. At 705, data representing the timestamp is stored. The data representing the timestamp may be stored as a bookmark, which may allow the user to later re-start presentation of the media program at the timestamp. The data representing the timestamp may also be used by a video recorder, which may record portions of the media program after the timestamp. Still, other implementations may be used.

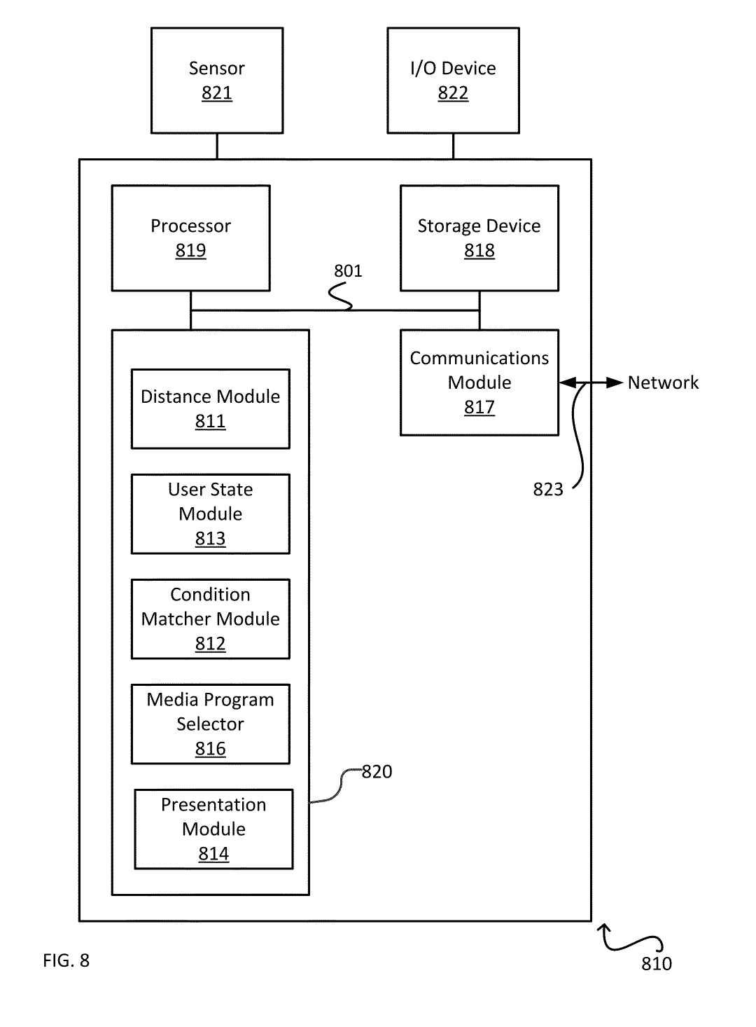

FIG. 8 illustrates a computer system suitable for use with a media content response manager, according to some examples. In some examples, computing platform 810 may be used to implement computer programs, applications, methods, processes, algorithms, or other software to perform the above-described techniques. Computing platform 810 includes a bus 801 or other communication mechanism for communicating information, which interconnects subsystems and devices, such as processor 819, system memory 820 (e.g., RAM, etc.), storage device 818 (e.g., ROM, etc.), a communications module 817 (e.g., an Ethernet or wireless controller, a Bluetooth controller, etc.) to facilitate communications via a port on communication link 823 to communicate, for example, with a computing device, including mobile computing and/or communication devices with processors. Processor 819 can be implemented with one or more central processing units (“CPUs”), such as those manufactured by Intel® Corporation, or one or more virtual processors, as well as any combination of CPUs and virtual processors. Computing platform 810 exchanges data representing inputs and outputs via input-and-output devices 822, including, but not limited to, keyboards, mice, audio inputs (e.g., speech-to-text devices), user interfaces, displays, monitors, cursors, touch-sensitive displays, LCD or LED displays, and other I/O-related devices. An interface is not limited to a touch-sensitive screen and can be any graphic user interface, any auditory interface, any haptic interface, any combination thereof, and the like. Computing platform 810 may also receive sensor data from sensor 821, including a heart rate sensor, a respiration sensor, an accelerometer, a GSR sensor, a bioimpedance sensor, a GPS receiver, and the like.

According to some examples, computing platform 810 performs specific operations by processor 819 executing one or more sequences of one or more instructions stored in system memory 820, and computing platform 810 can be implemented in a client-server arrangement, peer-to-peer arrangement, or as any mobile computing device, including smart phones and the like. Such instructions or data may be read into system memory 820 from another computer readable medium, such as storage device 818. In some examples, hard-wired circuitry may be used in place of or in combination with software instructions for implementation. Instructions may be embedded in software or firmware. The term “computer readable medium” refers to any tangible medium that participates in providing instructions to processor 819 for execution. Such a medium may take many forms, including but not limited to, non-volatile media and volatile media. Non-volatile media includes, for example, optical or magnetic disks and the like. Volatile media includes dynamic memory, such as system memory 820.

Common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, or any other medium from which a computer can read. Instructions may further be transmitted or received using a transmission medium. The term “transmission medium” may include any tangible or intangible medium that is capable of storing, encoding or carrying instructions for execution by the machine, and includes digital or analog communications signals or other intangible medium to facilitate communication of such instructions. Transmission media includes coaxial cables, copper wire, and fiber optics, including wires that comprise bus 801 for transmitting a computer data signal.

In some examples, execution of the sequences of instructions may be performed by computing platform 810. According to some examples, computing platform 810 can be coupled by communication link 823 (e.g., a wired network, such as LAN, PSTN, or any wireless network) to any other processor to perform the sequence of instructions in coordination with (or asynchronous to) one another. Computing platform 810 may transmit and receive messages, data, and instructions, including program code (e.g., application code) through communication link 823 and communication interface 817. Received program code may be executed by processor 819 as it is received, and/or stored in memory 820 or other non-volatile storage for later execution.

In the example shown, system memory 820 can include various modules that include executable instructions to implement functionalities described herein. In the example shown, system memory 820 includes distance module 811, user state module 813, condition matcher module 812, media program selector module 816, and presentation module 814. A media program and type library and a conditions library may be stored on storage device 818 or another memory.

Although the foregoing examples have been described in some detail for purposes of clarity of understanding, the above-described inventive techniques are not limited to the details provided. There are many alternative ways of implementing the above-described invention techniques. The disclosed examples are illustrative and not restrictive.

What is claimed:

1. A method, comprising:
receiving data representing a distance between a display and a wearable device is below a threshold;
receiving data representing a user state;
determining that a condition is satisfied based on the user state, the condition being associated with a type of media program;
selecting data representing a media program based on the type of media program; and
causing presentation of the data representing the media program and information associated with the user state at the display.

2. The method of claim 1, further comprising:
receiving sensor data from one or more sensors coupled to a wearable device; and
determining the user state using the sensor data.

3. The method of claim 1, further comprising:
receiving data representing a current time; and
determining that another condition is satisfied based on the current time, the another condition being associated with the type of media program.

4. The method of claim 1, wherein the causing presentation of the data representing the media program and information associated with the user state comprises:
causing presentation of the information associated with the user state as an overlay on the data representing the media program.

5. The method of claim 1, wherein the causing presentation of the data representing the media program and information associated with the user state comprises:
causing presentation of the data representing the media program using a modified resolution such that the data representing the media program is presented adjacent to the information associated with the user state.

6. The method of claim 1, further comprising:
determining one of contrast, brightness, and sharpness associated with the presentation of the data representing the media program based on the user state.

7. The method of claim 1, wherein the condition is further associated with presenting the information associated with the user state as an overlay on the data representing the media program.

8. The method of claim 1, further comprising:
receiving data representing another distance between the display and another wearable device;
determining the another distance is below the threshold;
receiving data representing another user state; and
causing presentation of information associated with the another user state at the display.

9. The method of claim 1, further comprising:
selecting data representing an animation associated with the user state; and
causing presentation of the data representing the animation at the display.

10. The method of claim 1, further comprising:
receiving data representing another user state;
identifying the another user state as comprising sleep;
identifying a timestamp associated with the presentation of the data representing the media content substantially at a time when the another user state is identified as including sleep;
causing termination of presentation of the data representing the media program; and
causing storage of data representing the timestamp.

11. The method of claim 1, wherein the condition comprises a number of steps taken by a user being below a threshold.

12. A system, comprising:
a memory configured to store data representing a distance between a display and a wearable device is below a threshold, and to store data representing a user state; and
a processor configured to determine that a condition is satisfied based on the user state, the condition being associated with a type of media program, to select data representing a media program based on the type of media program, and to cause presentation of the data representing the media program and information associated with the user state at the display.

13. The system of claim 12, wherein:
the memory is further configured to store sensor data received from one or more sensors coupled to a wearable device; and
the processor is further configured to determine the user state using the sensor data.

14. The system of claim 12, wherein:
the memory is further configured to receive data representing a current time; and
the processor is further configured to determine that another condition is satisfied based on the current time, the another condition being associated with the type of media program.

15. The system of claim 12, wherein:
the processor is further configured to cause presentation of the information associated with the user state as an overlay on the data representing the media program.

16. The system of claim 12, wherein:
the processor is further configured to cause presentation of the data representing the media program using a modified resolution such that the data representing the media program is presented adjacent to the information associated with the user state.

17. The system of claim 12, wherein:
the memory is further configured to store data representing another distance between the display and another wearable device, and to store data representing another user state; and
the processor is further configured to determine the another distance is below the threshold, and to cause presentation of information associated with the another user state at the display.

18. The system of claim 12, wherein:
the memory is further configured to store data representing another user state; and
the processor is further configured to identify the another user state as comprising sleep, to identify a timestamp associated with the presentation of the data representing the media content substantially at a time when the another user state is identified as including sleep, to cause termination of presentation of the data representing the media program, and to cause storage of data representing the timestamp.

19. The system of claim 12, wherein the user state comprises information associated with a sleep state.

20. The system of claim 12, wherein the user state comprises information associated with an activity.
